(19) United States
(12) Patent Application Publication
(10) Pub. No.: US 2009/0003460 A1
(43) Pub. Date: Jan. 1, 2009

(54) ENCODING APPARATUS AND ENCODING METHOD

(75) Inventors: Emi MARUYAMA, Tokyo (JP); Minoru OHTA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/163,932

(22) Filed: Jun. 27, 2008

(30) Foreign Application Priority Data
Jun. 29, 2007 (JP) 2007-172494

(51) Int. Cl. H04N 7/26

(52) U.S. Cl. 375/240.26; 375/E07.2

(57) ABSTRACT

To ease operations by a user carried out for compression-encoding video data and mitigate operational errors that might be caused upon the compression-encoding. In an encoding apparatus, an encode information input accepting section accept an input of first encode information used when video data is compression-encoded, a parameter setting section sets a parameter used when each short section is compression-encoded as a first parameter on the basis of the first encode information, an output section displays a change screen for changing the parameter while following a previously created chapter file, a parameter change section change the parameter from the first parameter to a second parameter on the basis of change information, a GOP configuration determination section determines a GOP configuration by using the first parameter while following the chapter file, and a compression-encoding section 49 performs a compression-encoding on the video data on the basis of the determined GOP configuration.

### BACKGROUND OF THE INVENTION

1. Field of the Invention

The present invention relates to an encoding apparatus and an encoding method. In particular, the invention relates to an encoding apparatus and an encoding method in which video data can be compression-encoded through a 2-pass encoding method.

2. Description of the Related Art

As a configuration in which a read head jumps at the time of reproducing compression-encoded video data, three configurations of a multi story, a multi angle, and a layer break are considerable. Herein, the multi story means a configuration in which not only a single consequent video is recorded on a DVD (Digital Versatile Disc) or an HD DVD (High Definition Digital Versatile Disc) but also a plurality of scenes are previously prepared, so that reproduction can be performed in accordance with a selection by a user. Then, the multi angle means a configuration in which reproduction is performed while switching over different scenes in the DVD or the HD DVD. Furthermore, the layer break means a configuration in which reproduction is performed while jumping between two layers (Layer 0 and Layer 1) in a two-layer type DVD or HD DVD.

In these configurations, various restrictions exist in terms of video compression which should be satisfied when the read head jumps at the time of reproducing the video data.

It should be noted that as a related art technology, there is known a technology disclosed in Japanese Unexamined Patent Application Publication No. 2002-171529.

In the past, on the basis of various pieces of information set in an encoding apparatus when the compression-encoding on the video data is performed, a main story or a side story is compressed-encoded through the 2-pass encoding method (2-stage method). After that, for parts corresponding to the three configurations of the multi story, the multi angle, and the layer break where various restrictions exist in terms of video compression which should be satisfied when the read head jumps at the time of reproducing the video data (an end portion part at the end of EVOB, an interleave unit part at the multi angle position, and the like)d the user inputs encode information used for performing the compression-encoding on the parts again (for example, information on a bit rate or the like). Then, the user instructs the encoding apparatus to perform partial re-encode (so-called 3rd pass encode) on these parts on the basis of the input encode information and carries out editing by replacing the already executed compression-encoded data based on the 2-pass encode regarding these parts.

For this reason, it is necessary for the user to carry out a large number of manual operations when the video data is compression-encoded, and there is a problem that the operations carried out for compression-encoding the video data are extremely troublesome to the user.

### SUMMARY OF THE INVENTION

Accordingly, the present invention has been made in view of the above-mentioned circumstances, and it is an object of the present invention to provide an encoding apparatus and an encoding method in which it is possible to ease operations carried out for compression-encoding video data and mitigate operational errors that might be caused at the time of the compression-encoding, and also an operational efficiency can be improved.

In order to solve the above-mentioned problem, according to an aspect of the present invention, there is provided an encoding apparatus, including: an input accepting unit configured to accept, in a case where video data having a plurality of reproduction paths is compression-encoded through a 2-pass encoding method, an input of first encode information used when all sections of the video data are compression-encoded; a setting unit configured to set a parameter used when each short section is compression-encoded as a first parameter on the basis of the first encode information whose input was accepted by the input accepting unit; a display unit configured to display a change screen for changing a parameter used in a predetermined short section included in the video data, in accordance with while following a previously created chapter file; a change unit configured to change on the basis of change information for changing the parameter used in the predetermined short section whose input has been accepted on the change screen displayed by the display unit, the parameter used in the predetermined short section from the first parameter to a second parameter; a determination unit configured to determine a GOP configuration upon compression-encoding of the video data, in accordance with the first parameter set by the setting-unit and the chapter file; and an encoding unit configured to compression-encode the video data at least on the basis of the GOP configuration determined by the determination unit and the first parameter.

In order to solve the above-mentioned problem, according to an aspect of the present invention, there is provided an encoding method, including: an input accepting step of accepting, in a case where video data having a plurality of reproduction paths is compression-encoded through a 2-pass encoding method, an input of first encode information used when all sections of the video data are compression-encoded; a setting step of setting a parameter used when each short section is compression-encoded as a first parameter on the basis of the first encode information whose input was accepted through a processing in the input accepting step; a display step of displaying a change screen for changing a parameter used in a predetermined short section included in the video data while following a previously created chapter file; a change step of changing on the basis of change information for changing the parameter used in the predetermined short section whose input has been accepted on the change screen displayed through a processing in the display step, the parameter used in the predetermined short section from the first parameter to a second parameter; a determination step of determining a GOP configuration upon compression-encoding of the video data, in accordance with the first parameter set through a processing in the setting step and the chapter file; and an encoding step of compression-encoding the video data at least on the basis of the GOP configuration determined through a processing in the determination step and the first parameter.

In the encoding apparatus and the encoding method according to the aspect of the present invention, in a case where the video data having the plurality of reproduction paths is compression-encoded through the 2-pass encoding method, the input of the first encode information used when all the sections of the video data are compression-encoded is accepted, the parameter used when each short section is compression-encoded is set as the first parameter on the basis of the first encode information whose input was accepted, the change screen for changing the parameter used in the predetermined short section included in the video data is displayed, in accordance with the previously created chapter file, the parameter used in the predetermined short section is changed from the first parameter to the second parameter on the basis of the change information for changing the parameter used in the predetermined short section whose input was accepted on the displayed change screen, the GOP configuration upon the compression-encoding of the video data is determined, in accordance with the set first parameter and the chapter file, and the video data is compression-encoded at least on the basis of the determined GOP configuration and the first parameter.

According to the aspect of the present invention, it is possible to ease the operations carried out for compression-encoding the video data and mitigate the operational error that might be caused at the time of the compression-encoding, and also the operational efficiency can be improved.

### BRIEF DESCRIPTION OF THE DRAWINGS

FIG. 1 illustrates a title configuration in a multi story;

FIG. 2 illustrates a title configuration in a multi angle;

FIG. 3 illustrates a schematic configuration of a track buffer model;

FIG. 4 is an explanatory diagram for describing an end portion included in video data;

FIG. 5 is a table for describing restriction items in which a maximum consumption velocity Vo at a decoder in a section, which is referred to as end portion existing at the end of EVOB, is standardized by HD DVD standard;

FIG. 6 is a table for describing restriction items common to multi angles of two types including one allowing a seamless jump at an arbitrary position in an interleave unit and the other not allowing the seamless jump;

FIG. 7 is a table for describing particular restriction items in the case of multi angle allowing a seamless jump at an arbitrary position in the interleave unit;

FIG. 8 is a table for describing restriction items of a pre unit (PREU) existing at the end of a continuous block;

FIG. 9 is an explanatory diagram for describing a conventional 2-pass encoding method and a partial re-encode;

FIG. 10 is a block diagram of an internal configuration of an encoding apparatus according to an embodiment of the present invention;

FIG. 11 is a block diagram of a functional configuration of the encoding apparatus of FIG. 10 which can be executed by a CPU;

FIG. 12 is a flowchart for describing a compression-encoding processing in the encoding apparatus of FIG. 11;

FIG. 13 illustrates a configuration of a chapter file stored in a storage section; and

FIG. 14 illustrates a title configuration of a chapter file recognized in the encoding apparatus of FIG. 11,

### DESCRIPTION OF THE PREFERRED EMBODIMENTS

Hereinafter, embodiments of the present invention will be described with reference to the accompanying drawings.

Here, before describing the embodiments of the present invention, some premises are described. First, as a configuration where a read head jumps when compression-encoded video data is reproduced, three configurations of a multi story, a multi angle, and a layer break are considerable. Herein, the multi story means a configuration in which not only a single consequent video is recorded in a DVD (Digital Versatile Disc) or an HD DVD (High Definition Digital Versatile Disc), but also a plurality of scenes are previously provided, so that reproduction in accordance with a selection of a user can be performed.

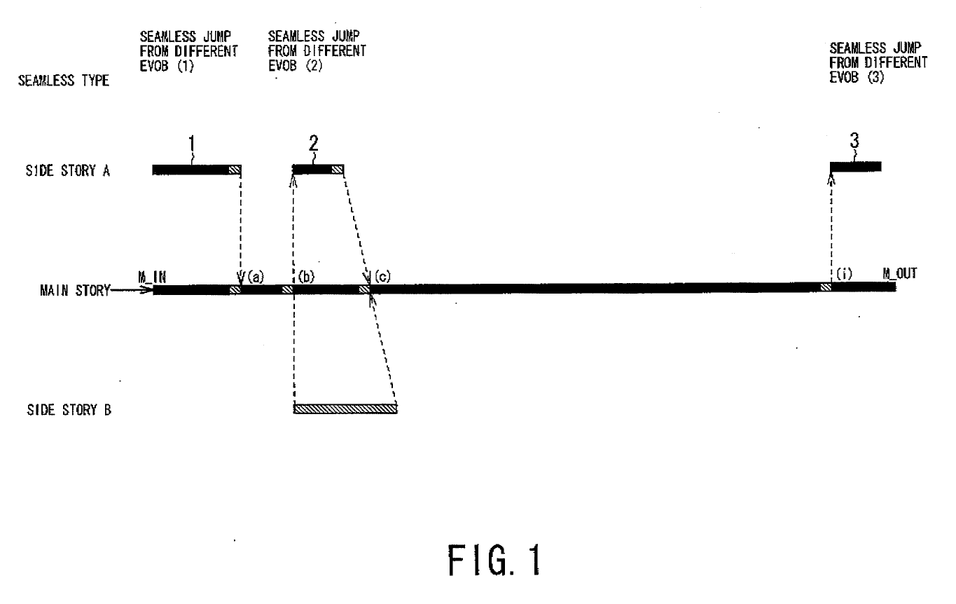

For example, a scene such as a violent scene which is not suitable to children and is not adopted as a main story is prepared separately from the main story. If an operation is made from a remote control of a user during reproduction, it is possible to reproduce the scene other than the main story in accordance with the operation. FIG. 1 illustrates an outline of a title configuration having a plurality of scenes which can be selected.

As illustrated in FIG. 1, for example, in a case where reproduction including a side story A is carried out, when the user selects the reproduction including the side story A on a menu screen, the video is reproduced in the following flow: reproduction of a short section 1 in the side story A→merge to the main story at (a)→reproduction of the main story→blanch to a short section 2 in the side story A at (b)→reproduction of the short section 2 in the side story A→merge to the main story at (c)→reproduction of the main story→blanch to a short section 3 in the side story A at (i)- At this time, a reproduction failure of the audio or the video should not be generated in the reproduction of the main story of course and also in the merge of the side story and the main story or at the blanching point. Such a configuration as illustrated in FIG. 1 is also referred to as seamless blanch other than the multi story.

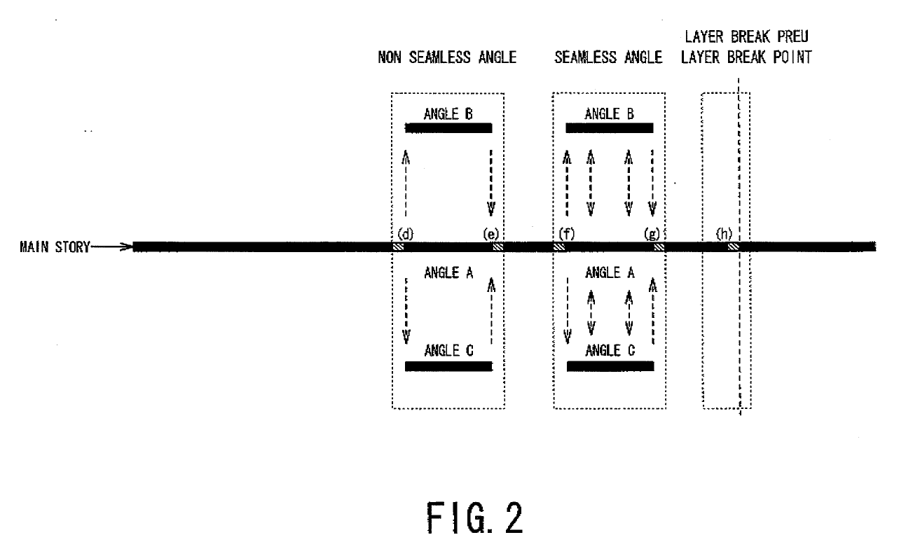

Then, the multi angle means a configuration in which different scenes are switched over to perform reproduction in DVD or HD DVD For example, a plurality of video images captured from different angles are prepared (for example, video images captured from angles A, B, C, D, etc.), and as illustrated in FIG. 2, a video image captured from a certain angle can be switched to a video image captured from a different angle in the middle of the reproduction.

Furthermore, in the two-layer type DVD or HD DVD in general, the two layers (Layer 0 and Layer 1) exist, and regarding the layer of Layer 0, record data is recorded on a further outer circumference as compared with the layer of Layer 1. As illustrated in FIG. 2, the layer break means a configuration in which reproduction is performed while jumping between two layers (Layer 0 and Layer 1) in a two-layer type DVD or HD DVD.

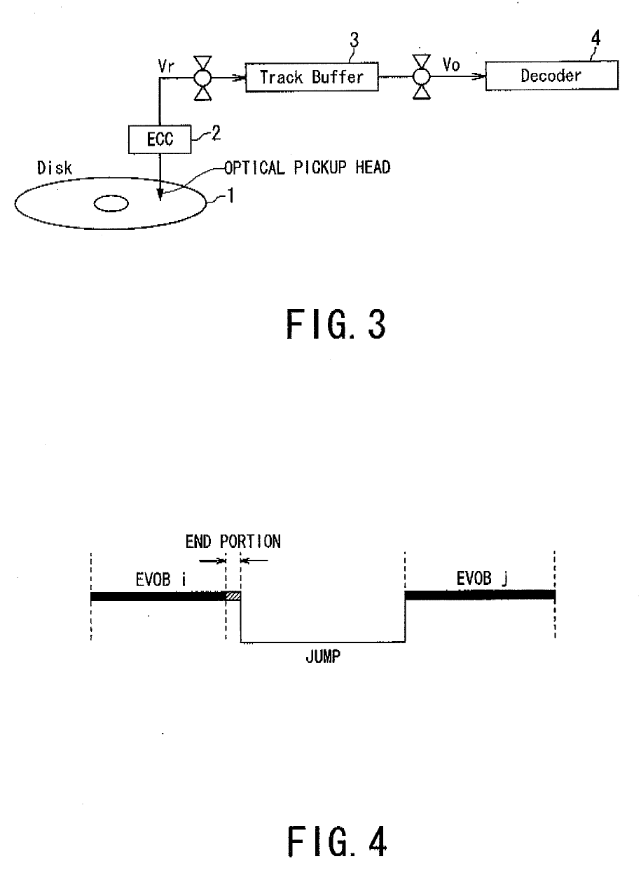

At the time of reproduction jumping over different layers, a jump of an optical pickup head over 100,000 sectors may be generated. In accordance with the jump amount of the optical pickup head, a restriction exists on the maximum rate with a consideration on a track buffer model which is illustrated in FIG. 3. In this manner, in these configurations, various restrictions exist in terms of video compression which should be satisfied when the read head jumps at the time of reproducing the video data.

Herein, these configurations (the multi story, the multi angle, and the layer break) will be described from a viewpoint of EVOB (Elementary video Object). In general, in HD DVD, a standard content and an advanced content exist, but the. EVOB exists in both the contents in common and complies with “The system part of the MPEG-2 Standard (ISO/IEC 13818-1)”. In this EVOB, reproduction information such as audio data and subtitle data is recorded.

The EVOB involves two types of a continuous block and an interleaved block. The continuous block means one EVOB arranged in a continuous logic sector, and the interleaved block means that a plurality of EVOs are divided and alternately arranged.

In the case of the multi story illustrated in FIG. 1, it is necessary that the main story sets borders of the EVOBs at (a), (b), (c), and (i), and the starting point and the end point of the side story, and each of them is configured of the continuous block. Then, in the case of the multi angle illustrated in FIG. 2, in order that a jump to a video image at a different angle can be carried out at an arbitrary position, it is necessary that each angle is configured of an interleave unit, and the starting point and the end point of each angle are set as borders of the EVOBs. Furthermore, in the case of the layer break illustrated in FIG. 2, it is necessary that the layer break point is set as the border of the EVOs. It should be noted that regarding the video phase at the border of EVOBs, when the previous EVOB ends at Top field, the following EVOB needs to start at Bottom field. On the other hand, when the previous EVOB ends at Bottom field, the following EVOB needs to start at Top field.

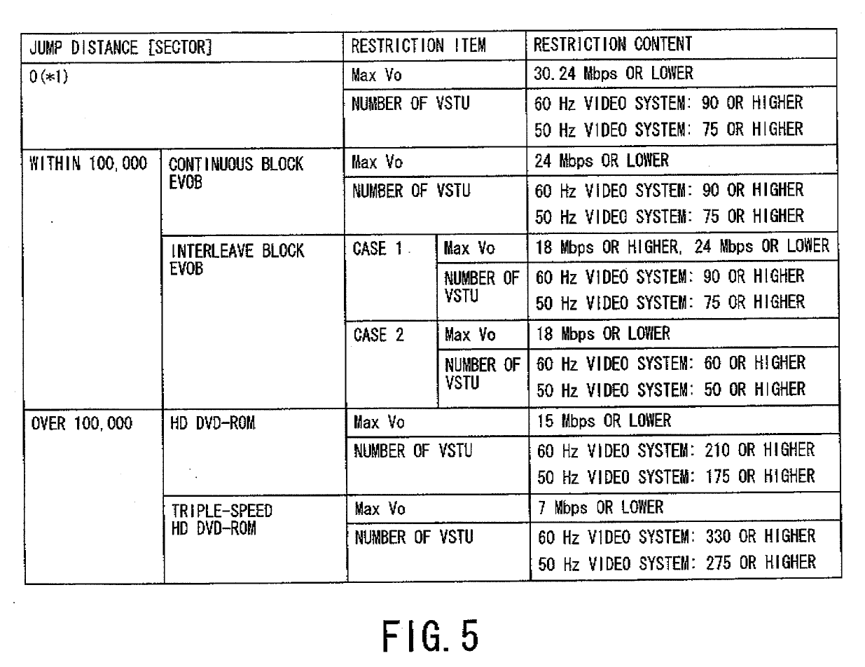

In addition, according to the DVD video standard or the HD DVD video standard, by utilizing a difference between a transfer velocity Vr from a disk 1 to a track buffer 3 and a consumption velocity Vo at a decoder 4, the data amount in the track buffer 3 is controlled. In order not to interrupt the reproduction due to the jump of the optical pickup head, in a jump between different EVOBs, as illustrated in FIG. 4, a certain section existing at the end of the previous EVOB (that is, a section called end portion) is provided, and the maximum consumption velocity Vo at the decoder 4 in this certain section is standardized by HD DVD standard (refer to a table of FIG. 5) VSTU (video System Time Unit) of FIG. 5 means a distance between continuous two frames or fields. In a system of 60 Hz, the distance is 1.001/60, and in a system of 50 Hz, the distance is 1/50. The restriction of the consumption velocity Vo at the end portion is determined in such a manner that the jump or the optical pickup head does not break the track buffer control.

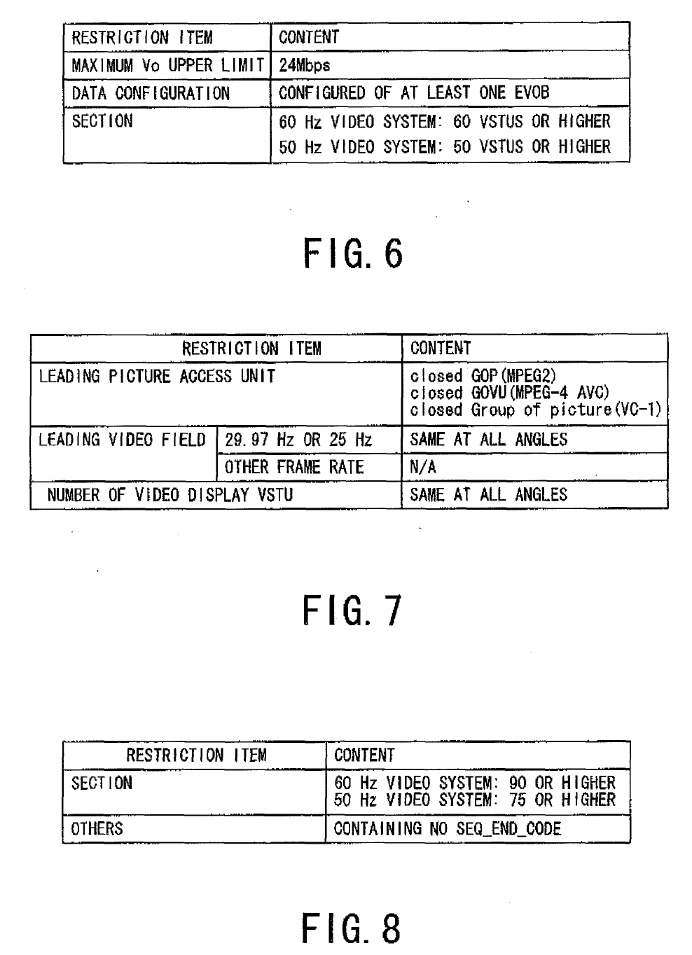

Furthermore, the multi angle is configured of the interleave unit. The multi angle has two types including one which is capable of seamlessly jumping at an arbitrary position in the interleave unit and the other which is incapable of seamlessly jumping thereat. Restriction items which are common to the two multi angles are illustrated in a table of FIG. 6. In the case of the multi angle which is capable of seamlessly jumping at an arbitrary position in the interleave unit, it is necessary to satisfy restriction items illustrated in a table of FIG. 7 in addition to the table of FIG. 6. In the case of the multi angle which is incapable of seamlessly jumping at an arbitrary position in the interleave unit, it suffices that only the table of FIG. 6 is satisfied.

In order to seamlessly connect from the continuous block to the interleave unit, a pre unit (PREU) needs to further exist at the end of the corresponding continuous block. Restriction items to this pre unit (PREU) are illustrated in a table of FIG. 8. It should be noted that SEQ_END_CODE illustrated in FIG. 8 means a separation point of the stream, and differs the name depending on a video compression-encoding method. For example, in the case of MPEG2, the name is called “sequence_end_code”. For example, in the case of MPEG4-AVC, the name is called “end_of_seq_bsp”. For example, in the case of VC1, the name is called “End_of_Sequence”. In addition, with regard to the pre unit (PREU), it is necessary to satisfy the maximum consumption velocity Vo at the decoder 4 which is equivalent to 100,000 or lower sectors jump and the EVOB of the continuous block, which are illustrated in the table of FIG. 5.

Herein, an encoding apparatus for performing a compression-encoding processing on video (so-called encoder) performs compression-encoding of an original image file specified after setting parameters such as a resolution and a bit rate. In the compression-encoding of a stored medium such as DVD in this encoding apparatus, a variable bit rate method is adopted unlike the compression-encoding of digital broadcasting. The variable bit rate method is that the bit amount is allocated in accordance with the complexity of the image included in the video data with restrictions such as a decoder buffer determined by the encoding standard for a purpose of normally carrying out the reproduction of video data and the maximum, the average, and the minimum bit rate values which are input prior to the encode processing (prior to the-compression-encoding processing). The bit rate used herein refers to the bit amount per second.

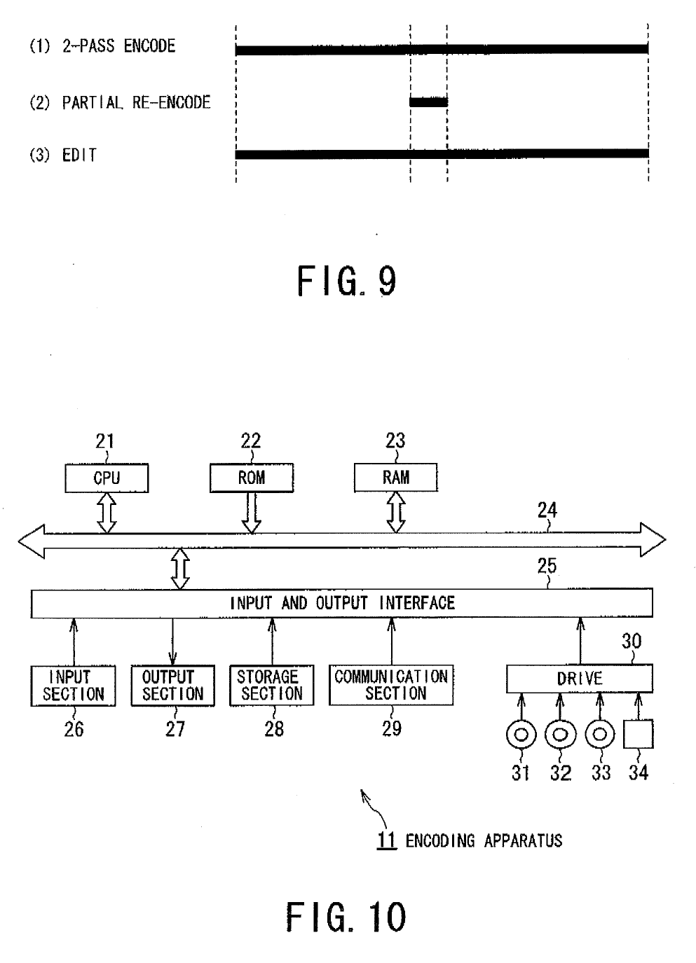

In this variable bit rate method, in general, an encoding method called 2-pass encoding is used. 2-pass means that encode is performed twice, and therefore, a 2-pass encoding method means an encode method based on 2-stage procedure. First, the encode (compression-encoding) for the first time investigates features of the image included in the video data. The encode (compression-encoding) for the second time carries out an appropriate bit amount allocation on the basis of information obtained form the result of the first encode. With this configuration, more appropriate variable bit rate encoding is performed ((1) of FIG. 9). In addition to the above-mentioned description, a 1-pass encode method means that the encode (compression-encoding) is carried out by only once. In general, on the basis of a set average rate, the bit amount allocation is carried out without considering of the complexity of the image included in the video data, and thus the 1-pass encode method adopts a fixed bit rate method in many cases.

Furthermore, in general, after the image quality evaluation is conducted by reproducing the stream completed as the result of the compression, re-adjustment of the parameters such as the bit rate is applied to a scene having a compression distortion and subsequently the compression is carried out again. This re-compression-encoding processing is referred to as partial re-encode (so-called 3rd pass encode) ((2) of FIG. 9). In this partial re-encode, after the encode (compression-encoding) is carried out only on the scene specified by the user, the replacement at the corresponding part is performed ((3) of FIG. 9). It should be noted that in order to enable the replacement at the corresponding part, the encode buffer occupying amounts at the beginning and the end of the corresponding part have a consistency with those at connections which are included in original stream.

However, in the past, as described above, on the basis of various pieces of information set by the user in the encoding apparatus at the time of compression-encoding of the video data, the main story or the side story is compressed-encoded in the 2-pass encoding method (two-stage method). After that, for the parts corresponding to the three configurations of the multi story, the multi angle, and the layer break in which various restrictions exist in terms of video compression which should be satisfied when the read head jumps at the time of reproducing the video data (the end portion part at the end of the EVOB, the interleave unit part of the multi angle portion, and the like), the user inputs the encode information used when the relevant parts are compression-encoded (for example, the information on the bit rate or the like) again. The encoding apparatus performs the partial re-encode on these parts on the basis of the input encode information. Then, the editing is carried out by replacing partially the compression-encoded data on the basis of the 2-pass encode with the 3rd pass encoded part. A representative parameter among parameters changed at the parts subjected to the above-mentioned restrictions is the maximum value of the bit rate. For example, when the entire encode is carried out in accordance with the maximum value of the bit rate at the parts where the restrictions exist, it is technically possible to create the compression-encoded data only by conducting the 2-pass encode without conducting the partial re-encode. However, if the maximum value of the bit rate is decreased, the image quality of data after the encoding compression is decreased. Accordingly, in the actual operation, the partial re-encode is conducted for decreasing the maximum value of the bit rate at the section subjected to the restrictions.

For this reason, the user needs to perform a large number of manual operations when the video data is compression-encoded, and the operations carried out for compression-encoding the video data are extremely troublesome to the user.

In view of the above, on the basis of a previously created chapter file, the parts corresponding to the three configurations of the multi story, the multi angle, and the layer break in which various restrictions exist in terms of video compression which should be satisfied (the end portion part at the end of the EVOB, the interleave unit part of the multi angle portion, and the like) and the parameters used when the compression-encoding is performed (for example, parameters related to the bit rate and the filter, and the like) are mechanically or automatically set. With this configuration, it is possible to ease the operations by the user carried out for compression-encoding the video data and mitigate the operational error that might be caused at the time of the compression-encoding, and the operational efficiency can be improved. Hereinafter, the compression-encoding method using this method will be described.

FIG. 10 illustrates an internal configuration of an encoding apparatus 11 according to an embodiment of the present invention.

As illustrated in FIG. 10, a CPU 21 executes various processings in accordance with programs stored in a POM 22 (for example, an encoder application program, and the like) or programs loaded from a storage section 28 to a RAM 23.

The RAM 23 also appropriately stores necessary data for the CPU 21 to execute various processings and the like.

The CPU 21, the ROM 22, and the RAM 23 are mutually connected via a bus 24. In addition, an input and output interface 25 is connected to the bus 24.

To the input and output interface 25, an input section 26 configured of a key board having various operation keys and a mouse, an output section 27 configured of a display such as a CRT (Cathode Ray Tube) or a LCD (Liquid Crystal Display), a speaker, and the like, the storage section 28 configured of hard disk or the like, and a communication section 29 configured of a modem, a terminal adapter, a network interface (all of which are not shown in the drawing), and the like, are connected. A communication section 29 is configured to perform a communication processing via a network not shown in the drawing.

Also, to the input and output interface 25, a drive 30 is connected when necessary. To the input and output interface 25, a magnetic disk 31 (including a floppy disk), an optical disk 32 (including CD-ROM (Compact Disk-Read only Memory) or DVD (Digital versatile Disk)), a magnet-optical disk 33 (including MD (Mini-Disk)), a semiconductor memory 34, and the like are appropriately mounted. Then, a computer program may be installed into the storage section 28 from the drive 30 when necessary.

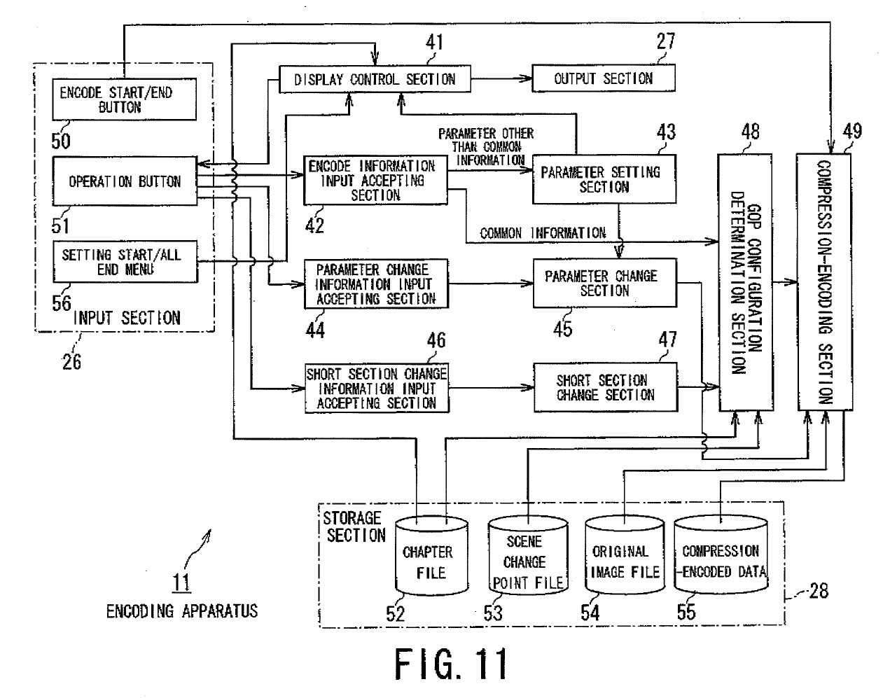

FIGS. 11 illustrates a functional configuration which can be executed by the CPU 21 in the encoding apparatus 11 of FIG. 10.

As illustrated in FIG. 11, the encoding apparatus 11 is configured of a display control section 41, an encode information input accepting section 42, a parameter setting section 43, a parameter change information input accepting section 44, a parameter change section 45, a short section change information input accepting section 46, a short section change section 47, a GOP configuration determination section 48, and a compression-encoding section 49.

When the user selects setting start command from among a setting start/all end menu 56 provided to the input section 26, the display control section 41 allows the encode information input accepting section 42 to accept an input from a operation key 51. The encode information input accepting section 42 specifies storage locations of the storage section 28 for various files in the encoding apparatus 11 (for example, the drive, the folder, and the like in the PC). The files used herein refer to chapter files that should be input, original image files, scene change files, and the output compression-encoded data (a compression-encoded video stream, a log file, etc). In addition, the encode information input accepting section 42 also specifies frames where the encoding in the original image file is started and ended, a frame rate, a scanning method (interlace method/progressive method). These pieces of information are pieces of common information, which are not changed by other functions in the encoding apparatus 11.

In accordance with a request from the operation key 51, the display control section 41 reads out a previously created chapter file 52 stored in the storage section 28 to recognize the configuration of the read out chapter file 52 and display an encode information screen on the output section 27 for inputting the encode information used when the video data (the original image file) corresponding to the chapter file 52 is compression-encoded.

Also, the display control section 41 displays a change screen on the output section 27 for changing parameters used when a predetermined section (for example, the end portion part or the section related to the interleave unit part) included in the video data is compression-encoded. In addition, when the user operates the operation key 51 provided to the input section 26, the encode information input accepting section 42 accepts the input of the encode information used when the video data (the original image file) corresponding to the chapter file 52 is compression-encoded and supplies the encode information whose input is accepted to the parameter setting section 43. Examples of the encode information whose input is accepted other than the common information include the bit rate and the like, which are parameters other than the common information that may be changed by other function sections.

The parameter setting section 43 obtains the encode information supplied from the encode information input accepting section 42, and on the basis of the thus obtained encode information, and sets the parameters used when the compression-encoding is performed on the video data (the original image file) corresponding to the chapter file 52. After that, the parameter setting section 43 supplies the display control section 41 with an instruction signal indicating that the parameters are set, and also supplies the parameter change section 45 with parameter setting data related to the set parameters.

The parameter change information input accepting section 44 accepts an input of change information for changing the parameters used at the time of compression-encoding a predetermined short section (for example, the end portion part or the section related to the interleave unit part) when the user operates the operation key 51 provided to the input section 26 and supplies the change information whose input has been accepted to the parameter change section 45.

The parameter change section 45 obtains the parameter setting data supplied from the parameter setting section 43 and also obtains the change information (change information for changing the parameters) supplied from the parameter change information input accepting section 44. The parameter change section 45 changes the parameters set by the parameter setting section 43 on the basis of the thus obtained change information. The parameter change section 45 supplies the parameter change information related to the changed parameters to the compression-encoding section 49.

The short section change information input accepting section 46 accepts an input of change information for changing a section in a predetermined short section described in the chapter file 52 (for example, the end portion part or the section related to the interleave unit part) (in other words, a section start time and a section end time) when the user operates the operation key 51 provided to the input section 26, and supplies the change information whose input has been accepted to the short section change section 47 and the GOP configuration determination section 48.

The short section change section 47 obtains the change information supplied from the short section change information input accepting section 46 (the change information for changing the section in a predetermined short section described in the chapter file 52 (in other words, a section start time and a section end time)), and changes the predetermined short section described in the chapter file 52 on the basis of the thus obtained change information. The short section change section 47 supplies the short section change data related to the thus changed predetermined short section to the GOP configuration determination section 48.

The GOP configuration determination section 48 reads out the chapter file 52 and a scene change point file 53 previously stored in the storage section 28, and also obtains the common information from the encode information input accepting section 42. In addition, the GOP configuration determination section 48 obtains the short section change data supplied from the short section change section 47. The GOP configuration determination section 48 determines the GOP configuration used at the time of the compression-encoding in the compression-encoding section 49 on the basis of the read out the chapter file 52 and the change scene point file 53 as well as the thus obtained common information supplied from the encode information input accepting section 42 and the short section change data, and supplies the data related to the determined GOP configuration to the compression-encoding section 49.

The compression-encoding section 49 obtains the data related to the GOP configuration supplied from the GOP configuration determination section 48 in response to a start command from an encode start/end button 50 of the input section 26, and reads out the original image file (video data) previously stored in the storage section 28. The compression-encoding section 49 uses the thus obtained data related to the GOP configuration to carry out the compression-encoding of the read out original image file 54 (video data) through the 2-pass encoding method. The compression-encoding section 49 stores compression-encoded data 55 obtained as the result of the compression-encoding in the storage section 28.

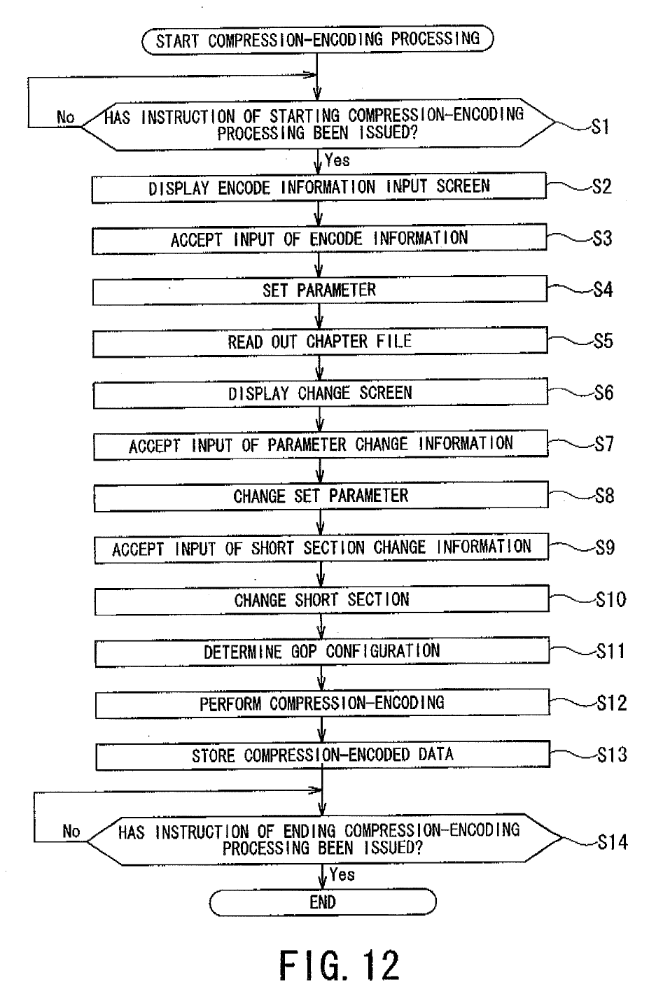

Next, with reference to a flowchart of FIG. 12, the compression-encoding processing in the encoding apparatus 11 of FIG. 11 will be described. This compression-encoding processing is started when the user operates the setting start/all end menu 56 provided to the input section 26.

In step S1, depending on the user operating the setting start/all end menu 56 provided to the input section 26, the display control section 41 determines whether setting start of the compression-encoding processing of the video data is instructed or not.

In step S1, in a case where the setting start of the compression-encoding processing of the video data is instructed, the flow is advance to step S2, where the display control section 41 controls the output section 27 to change the display so that various setting inputs can be performed with respect to encode information input accepting section 42. Until then, the setting inputs are not allowed. That is, the display control section 41 displays on the output section 27, the encode information screen for inputting this encode information used when the video data (the original image file 24) corresponding to the chapter file 52 is compression-encoded. The output section 27 displays the encode information screen for inputting the encode information in accordance with the control of the display control section 41.

In step S3, the encode information input accepting section 42 is allowed to accept the inputs when the user selects the setting start/all end menu 56 provided to the input section 26. The encode information input accepting section 42 receives storage locations of the chapter file, the original image file, scene change file, and the output compression-encoded data file (for example, the drive and the folder in the case of the PC) in the storage section 28. In addition, the encode information input accepting section 42 also receives the frame starting the encoding in the original image file (IN point) and the frame ending the encoding (OUT point). When the operation key 51 is operated, the input of the encode information used when the video data (the original image file 24) corresponding to the chapter file 52 is compression-encoded is accepted.

The IN/OUT points included in the encode information mean the encode start frame and end frame of the original image file 54. The IN point includes the encode start frame of the original image file 54 which is the relevant frame, and the OUT point does not include the encode end frame of the original image file 54 which is the relevant frame.

In addition, the frame rate which is one of the parameters used when the video data having the chapter file 52 (the original image file 54) is compression-encoded means the number of frames per 1 second. For example, in the case of moving pictures called interlace video of NTSC, the frame rate is 30/1001=29.97 Hz, and in the case of film materials, the frame rate is 24/1001=23.98 Hz. It should be noted that on the basis of the information related to this frame rate and the information related to IN/OUT points, the frame value can be converted into HH:MM:SS:FF called time code (HH=hour, MM=minute, SS=second, FF=frame number). In a time code system called no-drop system, this FF is a number system of base 30 from 0 to 29 in the case of 29.97 Hz, and in the case of 23.98 Hz, the FF is a number system of base 24 from 00 to 23. In general, the IN/OUT points and the section setting are set on the basis of time code values.

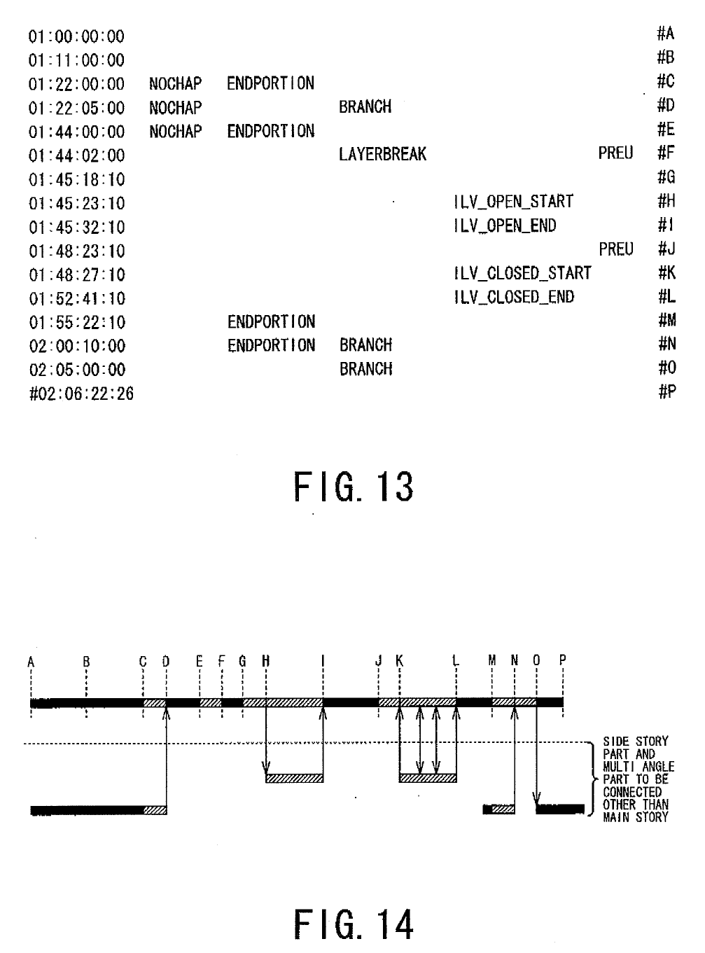

FIG. 13 illustrates a configuration of the previously created chapter file 52 stored in the storage section 28. In the chapter file 52 illustrated in FIG. 13, a branching point, a converging point, and a type in the video data are described.

For example, as illustrated in FIG. 13, on the chapter file 52, the branching point and the converging point are not distinguished from each other and are both defined as “BRANCH”. “NOCHAP” means that this is not a chapter point. “ENDPORTION” means a start point of an end portion. “LAYERBREAK” means a layer break point. “PREU” means a start point of PREU (pre unit). “ILV_OPEN_START” and “ILV_OPEN_END” mean interleaved blocks and also a starting point and an end point of an open GOP setting. “ILV_CLOSED_START” and “ILV_CLOSED_END” mean interleaved blocks and also a starting point and an end point of a closed GOP setting.

It should be noted that the original image file 54 stored in the storage section 28 refers to video data before being compressed. A format of the original image file 54 varies depending on the encoding apparatus 11, but pieces of pixel data are arranged in a set order to configure one screen (frame) in common. In MPEG2, as the original image file 54, a 4:2:0 format is utilized in which luminance data and color difference data respectively have 8 bit width, and also the color difference is thinning out by ½ in the horizontal direction and the vertical direction with respect to the luminance data. On the other hand, in MPEG4 AVC, the width of the pixel data is allowed from 8 bit to 12 bit width. Thus, in addition to the 4:2:0 format, MPEG4 AVC also deals with a 4:2:2 format where thinning out is performed only in the horizontal direction by ½ and a 4:4:4 format. For example, in the case of a film having a length of 2 hours (2×60 minutes×60 seconds×24 frames), the original image file 54 (video data) includes 172,800 frames worth of the 1-frame original image.

The encode information input accepting section 42 supplies the encode information whose input is accepted (information related to the parameters other than the common information) to the parameter setting section 43. After that, the parameter setting section 43 generates an instruction signal indicating that the parameters have been set and supplies the thus generated instruction signal indicating that the parameters have been set to the display control section 41.

In step S4, the parameter setting section 43 obtains the parameters other than the common information supplied from the encode information input accepting section 42, and sets the parameters used when the compression-encoding is performed on the video data (the original image file) corresponding to the chapter file 52 on the basis of the thus obtained parameters. For example, a bit rate, a weighting matrix with respect to a frequency component of a DCT conversion value called quantum matrix, a value related to a function of adaptively assigning the bit amount, an intensity of a de-block filter for suppressing block distortion in the case of MPEG4 AVC, and the like are set. It should be noted that at this time, the parameters set by the parameter setting section 43 is defined as “first parameters”.

Furthermore, the bit rate that should be set means the maximum, average, and minimum values in the case of the variable bit rater and in the case of the fixed bit rate, the bit rate that should be set means the average value.

In step S5, the display control section 41 reads out the previously created chapter file 52 stored in the storage section 28. The display control section 41 recognizes the configuration of the read out chapter file 52 as a title configuration illustrated in FIG. 14.

In step 56, on the basis of the instruction signal indicating that the parameters have been set which is supplied from the parameter setting section 43, the display control section 41 recognizes that the parameters have been set in the parameter setting section 43. Also, as the user operates the input section 26, on the basis of the encode information whose input has been accepted on the encode information screen, after the parameters used when the compression-encoding is performed on the video data (the original image file) corresponding to the chapter file 52 are set by the parameter setting section 43, the display control section 41 instructs the output section 27 to display a change screen for changing the parameters (for example, the bit rates (in particular, the maximum bit rate) etc.) which are used when the predetermined short section included in the video data (for example, the section related to the end portion part and the interleave unit part) is compression-encoded.

In accordance with the control of the display control section 41, the output section 27 displays the change screen for changing the parameters used when the predetermined short section included in the video data is compression-encoded. With this configuration, it is possible to request the user to set the maximum bit rates of the necessary portions.

In step S7, as the user operates the operation key 51 provided to the input section 26 on the change screen, the parameter change information input accepting section 44 accepts the input of the change information for changing the parameters used when the predetermined short section included in the video data (for example, the end portion part or the section related to the interleave unit part) is compression-encoded, and supplies the change information whose input has been accepted to the parameter change section 45.

Herein, the maximum consumption velocity Vo shown in the tables of FIGS. 5 to 8 refers to the rates of all data in a HD DVD title necessary for reproducing, not only the video, but also the audio, the subtitle, and the like. Therefore, with a consideration of the rates of the audio, the subtitle, and the like, as the user operates the input section 26, the maximum bit rates of the video and the like (the rates or ENDPORTION and PREU, etc.) are determined. Then, the input of the change information for changing the parameters which have been already set by the parameter setting section 43 (in particular, the first parameters such as the bit rate) is accepted. It should be noted that the parameters determined at this time such as the maximum bit rate are defined as “second parameters”. Therefore, this change information includes information for changing the parameters used when the predetermined short section included in the video data (for example, the end portion part or the section related to the interleave unit part) is compression-encoded from the first parameters to the second parameters.

In step S8, the parameter change section 45 obtains the parameter setting data supplied from the parameter setting section 43 and also obtains the change information (change information for changing the parameters) supplied from the parameter change information input accepting section 44. The parameter change section 45 changes the parameters set by the parameter setting section 43 on the basis of the thus obtained change information.

With this configuration, the parameters used when the predetermined short section included in the video data (for example, the end portion part or the section related to the interleave unit part) is compression-encoded are changed from the first parameters set by the parameter setting section 43 to the second parameters.

The parameter change section 45 supplies the parameter change information related to the changed parameters to the compression-encoding section 49. This parameter change data includes data for changing the parameters used when the predetermined short section included in the video data (for example, the end portion part or the section related to the interleave unit part) is compression-encoded from the first parameters to the second parameters.

In step S9, the short section change information input accepting section 46 accepts an input of change information for changing a time range (section) of a predetermined short section described in the chapter file 52 (for example, the end portion part or the section related to the interleave unit part) (in other words, a section start time and a section end time) when the user operates the operation key 51 provided to the input section 26 on the change screen, and supplies the change information whose input has been accepted to the short section change section 47.

For example, the input of change information for changing the section start time and the section end time of “ENDPORTION”, “BRANCH”, “LAYERBREAK”, “PREU”, “ILV_OPEN_START”, “ILV_CLOSE_START”, “ILV_OPEN_END”, and “ILV_CLOSE_END” is accepted.

In step S10, the short section change section 47 obtains the change information for changing the time range of a predetermined short section described in the chapter file 52 (in other words, a section start time and a section end time) supplied from the short section change information input accepting section 46, and change the predetermined short section described in the chapter file 52 on the basis of the thus obtained change information. The short section change section 47 supplies the short section change data related to the thus changed predetermined short section to the GOP configuration determination section 48. This short section change data include the data related to the thus changed predetermined short section (in other words, a section start time and a section end time).

In step S11, the GOP configuration determination section 48 reads out the chapter file 52 and the scene change point file 53 previously stored in the storage section 28, and also obtains the common information supplied from the parameter setting section 43. In addition, the GOP configuration determination section 48 obtains the short section change data supplied from the short section change section 47. The GOP configuration determination section 48 determines the GOP configuration used at the time of the compression-encoding in the compression-encoding section 49 on the basis of the read out the chapter file 52 and the scene change point file 53 as well as the thus obtained common information supplied from the encode information input accepting section 42 and the short section change data as illustrated in FIG. 14, for example, and supplies the data related to the determined GOP configuration to the compression-encoding section 49.

In step 512, as the user operates the encode start button among the encode start/end button 50 provided to the input section 26, a preparation for the compression-encoding processing of the video data is started. When the preparation for the compression-encoding processing is completed, the compression-encoding processing is started. The compression-encoding section 49 obtains the data related to the GOP configuration supplied from the GOP configuration determination section 48, and also reads out the original image file (video data) previously stored in the storage section 28. The compression-encoding section 49 uses the thus obtained data related to the GOP configuration to carry out the compression-encoding of the read out original image file 54 (video data) through the 2-pass encoding method. In Step 13, the compression-encoding section 49 stores the compression-encoded data obtained as the result of the compression-encoding in the storage section 28. Also, as the user operates the encode start button among the encode start/end button 50 provided to the input section 26, the compression-encoding processing is forcibly ended.

After that, in step S14, as the user selects the menu of all end among the start/all end menu 56 provided to the input section 26, the instruction for ending the compression-encoding processing of the video data is issued. The encoding apparatus 11 determines whether the instruction for ending the compression-encoding processing of the video data has been issued, and stands by until the determination is made as to whether the instruction for ending the compression-encoding processing of the video data is issued. In Step 14, in a case where it is determined that the instruction for ending the compression-encoding processing of the video data is issued, the compression-encoding processing is ended.

According to the embodiment of the present invention, in a case where video data having a plurality of reproduction paths is compression-encoded through a 2-pass encoding method, an input of first encode information used when all sections of the video data are compression-encoded is accepted, a parameter used when each short section is compression-encoded is set as a first parameter on the basis of the first encode information whose input has been accepted, a change screen for changing a parameter used in a predetermined short section included in the video data is displayed while following a previously created chapter file, the parameter used in the predetermined short section is changed from the first parameter to a second parameter on the basis of change information for changing the parameter used in the predetermined short section whose input has been accepted on the displayed change screen, a GOP configuration upon compression-encoding of the video data is determined while following the input first parameter and the chapter file, and the video data can be compression-encoded on the basis of the set first parameter, the changed second parameter, and the COP configuration.

Furthermore, on the basis of the change information for changing the time range in the predetermined short section described in the chapter file whose input has been accepted on the displayed change screen, the time range in the predetermined short section is changed, and by using the changed time range in the predetermined short section, while following the chapter file, it is possible to determine the COP configuration used when the video data is compression-encoded.

With this configuration, the setting of the GOVU configuration determined in the title configuration can be automatically changed with use of the chapter file including the title configuration. Therefore, the user does not need to perform a large number of manual operations when the video data is compression-encoded, and the user operations performed when the video data is compression-encoded can be mitigated. In addition, while observing the entire title configuration, when the chapter file is described, it is possible to mitigate the operational mistakes that might be caused along with the setting of the individual rates, and also the operational efficiency can be improved. Therefore, it is possible to improve the operability of the encoding apparatus.

It should be noted that the series of the processing described according to the embodiment of the present invention can be executed by using software but also be executed by using hardware.

Also, according to the embodiment of the present invention, such a processing example has been described that the steps of the flowcharts are processed in a time series manner in the stated order, but the present invention also encompasses a processing in which the steps are not necessarily processed in the time series manner and the steps are processed in a parallel manner or processed individually.

What is claimed is:

1. An encoding apparatus, comprising:
an input accepting unit configured to accept, in a case where video data having a plurality of reproduction paths is compression-encoded through a 2-pass encoding method, an input of first encode information used when all sections of the video data are compression-encoded;
a setting unit configured to set a parameter used when each short section is compression-encoded as a first parameter on the basis of the first encode information whose input was accepted by the input accepting unit;
a display unit configured to display a change screen for changing a parameter used in a predetermined short section included in the video data, in accordance with a previously created chapter file;
a change unit configured to change on the basis of change information for changing the parameter used in the predetermined short section whose input was accepted on the change screen displayed by the display unit from the first parameter, the parameter used in the predetermined short section from the first parameter to a second parameter;
a determination unit configured to determine a GOP configuration upon compression-encoding of the video data, in accordance with the first parameter set by the setting unit and the chapter file; and
an encoding unit configured to compression-encode the video data at least on the basis of the GOP configuration determined by the determination unit and the first parameter.

2. The encoding apparatus according to claim 1, wherein:
the change unit changes a section in the predetermined short section on the basis of change information for changing a section in the predetermined short section described in the chapter file whose input was accepted on the change screen displayed on the display unit; and
the determination unit determines the GOP configuration upon the compression-encoding of the video data with use of the section changed by the change unit in the predetermined short section, in accordance with the chapter file.

3. The encoding apparatus according to claim 2, wherein the change information for changing the section in the predetermined short section described in the chapter file includes a section start time or a section end time of the predetermined short section.

4. The encoding apparatus according to claim 1, wherein the predetermined short section includes an end portion part and an interleave unit part.

5. The encoding apparatus according to claim 1, wherein the parameter used when each short section is compression-encoded includes at least a bit rate.

6. An encoding method, comprising:
an input accepting step of accepting, in a case where video data having a plurality of reproduction paths is compression-encoded through a 2-pass encoding method, an input of first encode information used when all sections of the video data are compression-encoded;
a setting step of setting a parameter used when each short section is compression-encoded as a first parameter on the basis of the first encode information whose input was accepted through a processing in the input accepting step;
a display step of displaying a change screen for changing a parameter used in a predetermined short section included in the video data, in accordance with a previously created chapter file;
a change step of changing on the basis of change information for changing the parameter used in the predetermined short section whose input was accepted on the change screen displayed through a processing in the display step from the first parameter, the parameter used in the predetermined short section from the first parameter to a second parameter;
a determination step of determining a GOP configuration upon compression-encoding of the video data, in accordance with the first parameter set through a processing in the setting step and the chapter file; and
an encoding step of compression-encoding the video data at least on the basis of the GOP configuration determined through a processing in the determination step and the first parameter.
